(19) United States
(12) Patent Application Publication
(10) Pub. No.: US 2003/0091473 A1
(43) Pub. Date: May 15, 2003

(54) Automated centrifuge and method of using same

(76) Inventors: Robert Charles Downs, La Jolla, CA (US); Scott Allan Lesley, San Diego, CA (US); James Kevin Mainquist, San Diego, CA (US); Andrew J. Meyer, San Diego, CA (US); Christopher M. Shaw, San Diego, CA (US); Mark Richard Weselak, San Diego, CA (US); Marc Nasoff, San Diego, CA (US)

Correspondence Address: QUINE INTELLECTUAL PROPERTY LAW GROUP, P.C., P O BOX 458, ALAMEDA, CA, 94501, US

(21) Appl. No.: 09/780,589

(22) Filed: Feb. 8, 2001

(51) Int. Cl. B01L 3/00

(52) U.S. Cl. 422/72; 422/104; 422/99; 436/45

(57) ABSTRACT

An automated centrifuge comprising a rotor having a plurality of cavities located in the rotor. A tube is structured to be insertable into any one of the cavities and a controller is configured to insert the tube into the cavity. The cavities located in the rotor are grouped in clusters, and the cavities of each cluster are substantially parallel.

Also, an automated centrifuge system comprising a rotor including a plurality of clusters of holes, each hole including a longitudinal axis, with the longitudinal axes of each cluster of holes being substantially parallel. A plurality of moveable tubes are arranged in at least two groups, with each group of tubes configured to be received into adjacent clusters of holes. A rotor position member is structured to determine the position of each cluster of holes. A controller directs the tubes into the adjacent clusters of holes, and directs the rotor position member to rotate the rotor to another cluster of holes.

### FIELD OF THE INVENTION

The present invention relates to the field of centrifuge technology. More particularly, the present invention relates to an automated centrifuge that is compatible with a multiple process operation such as a high throughput system.

### BACKGROUND OF THE INVENTION

Centrifugation is a key technology in many fields and industries. It may be performed on a mass production scale or an experimental, bench top scale. For example, centrifuges are used in a wide variety of disciplines, including the chemical, agricultural, medical and biological fields. In particular, centrifuge technology is integral to chemical syntheses, cell separations, radioactive isotope analyses, blood analyses, assaying techniques, as well as many other scientific applications.

The recent identification of the more than 140,000 genes comprising the human genome highlights one important use of centrifuge technology, namely the determination of each gene's function, which has become of paramount importance. Because each gene makes at least one protein, more than 140,000 proteins must be grown and isolated to understand the function of each gene in the human genome. Centrifugation is an important step in isolating and separating proteins, but protein isolation frequently requires several labor intensive and time-consuming sequential procedures that often involve more than one centrifugation step for each isolation process.

Particularly for commercial applications, these proteins and other products utilizing centrifuge technology must be synthesized, analyzed or isolated on a production scale. Production scale processes emphasize limited human intervention and automated processes to increase output and efficiency. In an assembly line fashion, automated equipment enables high throughput processing of industrial scale amounts of material without disrupting the synthesizing, analyzing, or isolating process at each individual processing step. For example, automated liquid dispensers, aspirators, and specimen plate handlers facilitate the handling and testing of hundreds of thousands of samples per day with limited human interaction with the actual sample from beginning to end of the entire analysis process. In a further example, sample materials are automatically dispensed into multiple well specimen plates, reagents are added and removed via automated liquid dispensers and aspirators, and the specimen plates are transferred to each successive processing station by automated plate handlers. This increased production efficiency is premised in part on the viability of conducting the entire production process in the specimen plate. Similarly, automated procedures enable the synthesis of commercial pharmaceuticals from starting reagents to finished product without disrupting the production process with cumbersome, inefficient steps such as changing a sample vessel or transferring the sample vessels to another processing station.

Likewise, rapid advances in laboratory equipment have transitioned traditional laboratory bench top processes to more automated high-throughput systems. Unfortunately, limits in current centrifuge technology prevent the uninterrupted processing flow that characterizes automated high throughput systems.

These and other disadvantages are highlighted in a typical protein isolation process. Generally, a sample is centrifuged, removed from the centrifuge and a portion of the sample is removed, often by aspiration, from the sample at a separate processing station. At yet another processing station, a reagent is often dispensed into the remaining sample, followed by sonication in a separate sonication device (also at another processing station). Once the contents of the sample have been sonicated, the sample is placed back in the centrifuge and undergoes another centrifugation step. Frequently, this centrifugation-aspiration-dispensing-sonication-centrifugation cycle is repeated more than once for a particular protein isolation.

This cycle and all its drawbacks are also representative of many other applications involving centrifugation. Disadvantageously, typical sonication and centrifugations steps are not amenable to automated processing flows because of the need to physically transfer large numbers of samples to and from various processing stations. For example, in the example described above, a sample must be moved from a centrifugation station to an aspirating station, to a dispensing station, to a sonication station, and back to a centrifugation station. Unfortunately, this cycle may be repeated several times before a particular protein or other targeted material is isolated. Accordingly, the labor-intensive nature of the isolation process poses severe time constraints and cost increases, particularly when integration of the centrifuge step or the sonication step into an automated multiple process system is currently unavailable.

As centrifugation remains a key processing step in a number of industries, and particularly in biotechnology industries, a critical need exists for incorporating centrifugation processes into current multiple process systems such as automated high throughput systems. Developing a method and apparatus that reduces the need to transfer samples to a separate processing station for each processing step is essential to integrating centrifugation into modem production processes such as an automated high throughput system.

### SUMMARY OF THE INVENTION

The present invention alleviates to a great extent the deficiencies of known centrifugation processes by providing an automated centrifuge system that incorporates several processing steps within a single processing station. Briefly, the automated centrifuge system includes at least one centrifuge rotor defining a cavity. One or more movable sample vessels are structured to be insertable into the cavity. A transport is configured to position and insert one or more movable sample vessels into the cavity. Once the sample vessels are inserted into the cavity, the system performs a fluid-movement function such as aspiration, dispensing, or sonication.

One embodiment of the automated centrifuge system employs a centrifuge rotor defining a cluster of rotor apertures (also referred to as “holes”) located in the rotor. Each aperture has a longitudinal axis and the longitudinal axes of the cluster of rotor holes preferably are substantially parallel, although any arrangement of rotor holes may be used that can suitably receive and position sample vessels. A group of movable sample vessels are positioned by a transport so that the movable sample vessels are capable of being inserted into the cluster of rotor apertures.

The automated centrifuge system of the present invention affords several advantages. For example, the rotor cavities are grouped in sets with each cavity in the set being substantially parallel to all the other cavities in the set. Such an arrangement permits the simultaneous insertion of a group of tubes for further processing steps such as automated aspiration or dispensing of fluids without removing the sample vessels to a separate processing station. In addition, a sonication device can also be inserted simultaneously with the aspiration/dispensing tube. Advantageously, suspended materials can be centrifuged, aspirated, sonicated, and centrifuged again without the removal of the sample vessels from the centrifuge and without human intervention. The present invention introduces numerous advantages over current technology in that multiple-step procedures involving centrifugation that formerly required substantial human involvement and physical transfer of sample vessels to separate processing stations are now incorporated into an apparatus that performs multiple step processes at a single processing station.

Moreover, the automated centrifuge system of the present invention increases the reproducibility of experimental results, thereby decreasing the possibility of operator variation or error. Accordingly, other advantages of the present invention include reducing operator error and increasing the consistency and reliability of experimental results.

In one aspect the present invention provides an automated centrifuge system. The system includes: (a) a group of movable tubes, each tube structured to transport a liquid; (b) a cluster of rotor holes located in a rotor, the cluster of rotor holes arranged to receive the group of movable tubes; and (c) a transport holding the movable tubes and constructed to substantially simultaneously move the group of tubes into the cluster of rotor holes.

The automated centrifuge system may include: (a) a rotor; (b) a cavity located in the rotor; (c) a tube structured to be insertable into the cavity; (d) a transport coupled to the tube; and (e) a controller communicating with the transport, the controller directing the transport to insert the tube into the cavity. Alternatively, the automated centrifuge system includes: (a) a cluster of holes located in a rotor; (b) a group of tubes configured to be received into the cluster of holes; (c) a transport operably coupled to the group of tubes; and (d) a controller that directs the transport to insert the group of tubes into the cluster of holes. The system may also include: (1) a second rotor, the second rotor including a cluster of holes; and (2) a movable platform coupled to the transport; wherein the movable platform moves the transport to selectively position the group of tubes for insertion into the cluster of holes in the rotor and into the cluster of holes in the second rotor.

In another aspect, the automated centrifuge includes: (a) means for placing a plurality of vessels in a plurality of centrifuge rotor cavities; (b) means for substantially isolating a majority of a component located in each vessel by centrifugation; (c) means for re-suspending a majority of the component in a first group of vessels; and (d) means for substantially simultaneously dispensing a substance into a second group of vessels.

In still another aspect, the invention provides a method of automated centrifugation. The method includes the steps of: (a) placing a vessel in a centrifuge rotor cavity; (b) substantially isolating a majority of a component located in the vessel by centrifugation; and (c) re-suspending a majority of the component while the vessel is located in the centrifuge rotor cavity. In another aspect the method of automated centrifugation includes the steps of: (a) arranging a cluster of cavities on a centrifuge rotor, each cavity configured to receive a sample; (b) inserting a set of elongated tubes into the cluster of cavities, each tube being inserted into a corresponding cavity for depositing a liquid in each cavity; and (c) centrifuging the liquid and the sample.

The inventions also features a centrifuge rotor. The rotor includes a cluster of holes located in the centrifuge rotor, each hole including a longitudinal axis. The longitudinal axes of the cluster of holes are substantially parallel.

Other aspects of the invention feature: (a) automated loading and unloading of the centrifuge rotor using a robot; (b) automated manipulation of samples in vessels in a centrifuge rotor using a robot; (c) an automated method for moving samples into cavities of a centrifuge rotor using a robot; (d) an automated method for manipulating samples in vessels in a centrifuge rotor using a robot; (e) controller logic (i.e., the logic for controlling the various automated operations of the system, as well as the sample tracking logic); and (f) an overall automated method.

The number of various elements or steps of the invention may be modified. For example, in preferred embodiments, the rotor body may comprise 1, 2, 3, 4, 5, 6, 7, 8 or any whole number of clusters and each cluster may have 1, 2, 3, 4, 5, 6, 7, 8, 9, 10, 11, 12, 13, 14, 15, 16 or any whole number of cavities. The number of cavities or clusters can thus be, for example, any integer between 1 and 100, preferably between 1 and 50 and more preferably between 1 and 25. In addition, the robot is capable of positioning at least 2 centrifuge vessels, for example, into cavities in a same cluster of the centrifuge rotor at the same time. Again, any number of centrifuge vessels can be positioned by the robot in such a manner, preferably the number is any integer between 1 and 100, more preferably between 1 and 50 and most preferably between 1 and 25. Finally, the plurality of probes are capable of performing a function on at least 3 different samples, for example, at the same time. The probes, however, may be able to perform a function on at least any number of different sample at the same time, preferably the number of different samples is any integer between 1 and 100, more preferably between 1 and 50 and most preferably between 1 and 25.

The systems, devices and methods of the present invention preferably may also include means or steps for recognizing specific tubes or vessels, or groups of tubes or vessels, as they are placed into the centrifuge and/or me or steps for indexing or tracking one or more tubes or vessels as they are transferred from the centrifuge to another system, device or method, for example a fermentor. For example, the system, device or method may incorporate barcodes or colors to achieve the above, either manually or robotically.

### BRIEF DESCRIPTION OF THE DRAWINGS

These and other features and advantages of the present invention will be appreciated from the following detailed description, along with the accompanying figures in which like reference numerals identify like elements throughout and wherein:

FIG. 1 is a perspective view showing a centrifuge rotor constructed according to the present invention and a group of sample vessels inserted therein;

FIG. 2 is a plan view of the embodiment illustrated in FIG. 1;

FIG. 2A is a phantom view of the embodiment illustrated in FIG. 2;

FIG. 3 is a plan view of an alternative embodiment centrifuge rotor constructed according to the present invention;

FIG. 4 is a side elevation view of a rotor cavity constructed according to the present invention;

FIG. 5 is a perspective view of a section of a rotor constructed according to the present invention and a schematic block diagram of associated components of the present invention;

FIG. 6 is a perspective view of the fraction collector depicted schematically in FIG. 5;

FIG. 7 is a perspective view of some of the components depicted schematically in FIG. 5;

FIG. 8 is an elevation view of one embodiment of the automated centrifuge of the present invention;

FIG. 9 illustrates the rotor and rotor cover illustrated in FIG. 7 and also illustrates the rotor control box of the present invention;

FIG. 10 is a side elevation view of a rotor constructed according to the present invention and a schematic block diagram of associated components of the present invention; and

FIG. 11 illustrates one image projected on the operator interface illustrated in FIG. 8.

FIG. 12 is a perspective view of an alternative embodiment of the automated centrifuge of the present invention;

FIG. 13 is a perspective view of a section of a rotor employed in the centrifuge illustrated in FIG. 12;

FIG. 14 is a plan view of the rotor illustrated in FIG. 13;

FIG. 15 is a perspective view of a transport and waste trough illustrated in FIG. 12;

FIG. 16 is a perspective view of the waste trough illustrated in FIG. 15; and

FIG. 17 is a perspective view of a fraction collector illustrated in FIG. 12.

Some or all of the Figures may be schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the figures. Throughout this description, the preferred embodiment and examples shown should not be considered as limiting the scope of the present invention.

Described below are: (a) an automated centrifuge system, (b) the functions of the automated centrifuge, and (c) an alternative automated centrifuge system.

I. Automated Centrifuge System

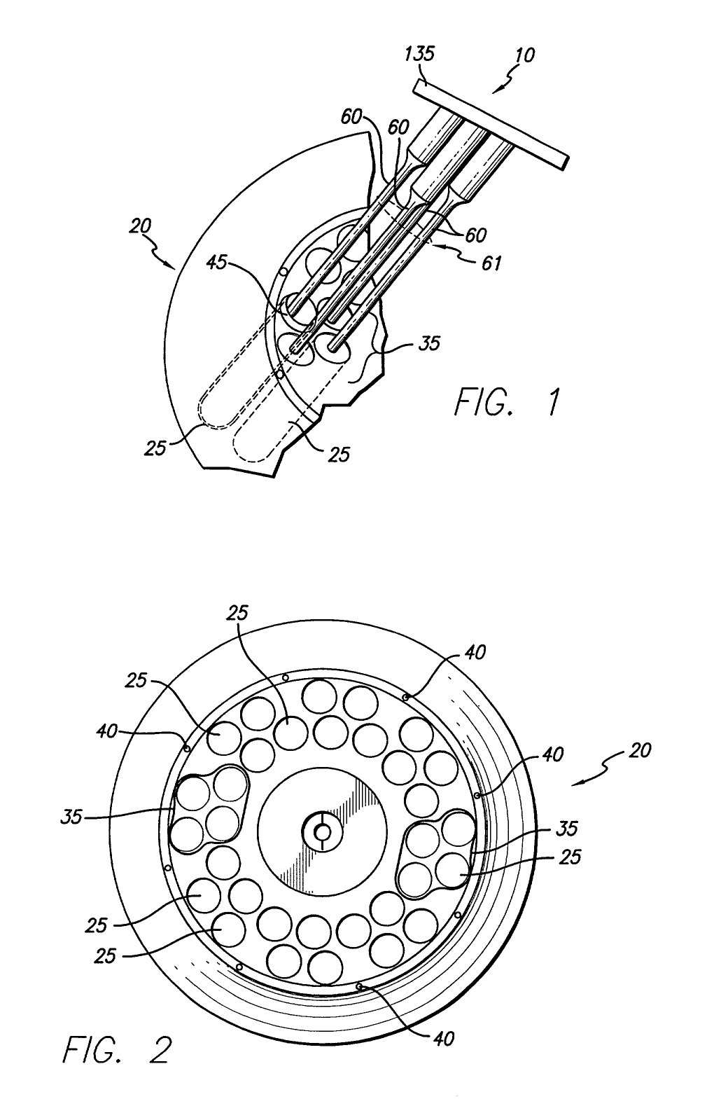

Referring to FIG. 1, an automated centrifuge system 10 is shown. Generally, the automated centrifuge system 10 comprises a rotor 20 having a cluster 35 of cavities 25 arranged to cooperate with a group of tubes 61. Each cavity 25 in the cluster 35 holds a sample, while each tube 60 is used to aspirate or dispense a fluid from its associated cavity. The group of tubes 61 are moved by a transport 135 so that each tube 60 in the group of tubes 61 is insertable into an associated cavity 25 in the cluster 35. Accordingly, the cooperative and complementary arrangement of the cluster 35 and the group of tubes 61 enable the efficient automated processing of samples held in each cavity 25.

For example, the rotor 20 may be rotated until the cluster 35 is positioned in a cooperative manner with the group of tubes 61. The rotor 20 then may be held in place when each tube 60 is positioned so that it is insertable into a corresponding cavity 25. When positioned, the transport 135 is moved to cause the tubes 60 to be inserted into the cavities 25. Once inserted, the tubes provide a fluid movement function, such as dispensing a buffer or aspirating a fluid product. When the fluid movement function is complete, the transport moves to cause the tubes 60 to be removed from the cavities 25. With the tubes 60 removed, the rotor 20 may be freed and the samples centrifuged, for example.

Several clusters 35 preferably are arranged radially on the rotor 20. As the rotor 20 is rotated, different sets of cavities 25 are positioned to receive the group of tubes 61. In such a manner, each set of cavities 25 in a rotor 20 may be acted upon by the same group of tubes 61 in a sequential manner. With the automated centrifuge system 10, a rotor 20 can be loaded with many samples, and a complicated multiple step process performed on each sample without any human intervention. More specifically, several centrifugation, dispensing, and aspirating steps can be performed with controlled accuracy and repeatability using the automated system. Accordingly, a process, such as a protein isolation process, may be performed more efficiently, more quickly, and more reliably than by using a conventional system.

Referring again to FIG. 1, the rotor 20 in the centrifuge system 10 contains a plurality of cavities 25 arranged in a cluster 35. Each cavity 25 has a longitudinal axis, and in a preferred embodiment the longitudinal axes of each cavity 25 in each cluster 35 are substantially parallel to each other. Positioned within the cavities 25 are tubes 60 that are coupled to a robotic actuator or transport 135. In the embodiment illustrated, the tubes 60 are arranged in a set and can be substantially simultaneously inserted into the cavities 25 because the longitudinal axes of the cavities 25 are substantially parallel to the longitudinal axes of the tubes 60. In this manner, a plurality of tubes 60 can be inserted into a plurality of cavities 25.

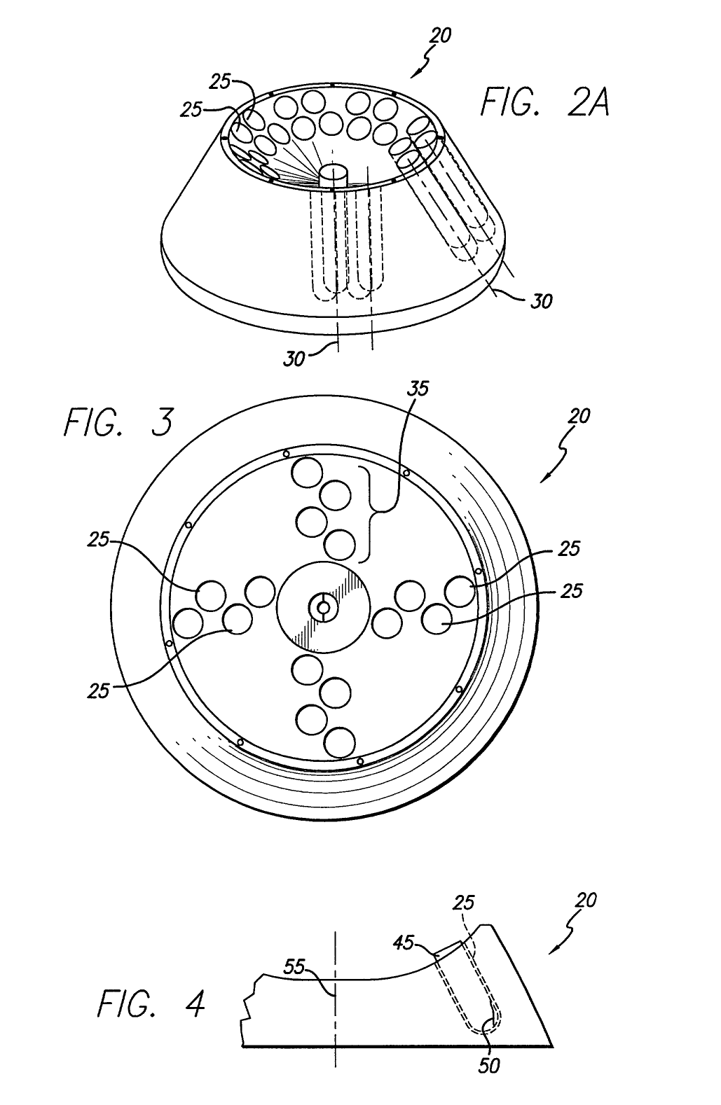

Referring to FIGS. 2 and 2A, another aspect of the present invention is illustrated. A centrifuge rotor 20 for use in a centrifuge system contains a plurality of cavities 25, or rotor holes. Although in the preferred embodiment the cavity 25 is a rotor hole, the cavity may take other forms. For example, the cavity may be a well in a sample plate. Each cavity 25 has a longitudinal axis 30 and is configured to receive a vessel 45 (not shown). In the preferred embodiment, the vessel 45 holds a biological sample. However, the biological sample, or any other sample, may be placed directly in the cavity to satisfy application specific needs.

As shown in FIGS. 2 and 2A, the rotor holes are arranged in clusters 35. In the embodiment illustrated, the cluster 35 comprises four cavities 25. The longitudinal axis 30 of each cavity 25 in each cluster 35 are substantially parallel. As illustrated in FIG. 3, the clusters 35 can be arranged substantially radially in the centrifuge rotor 20, as shown in FIGS. 2 and 2A. In contrast to conventional centrifuge rotors that have individual rotor holes with non-parallel longitudinal axis, the rotor 20 of the present invention arranges clusters 35 where the cavities are substantially parallel in a cluster and it is only the clusters 35 that are radially arranged on the rotor. The number of cavities 25 in each cluster 35 can vary depending upon the size of the rotor 20 and the size of the cavities 25. The number of clusters 35 in each rotor 20 can also vary. For example, a preferred embodiment centrifuge rotor 20 has 32 cavities 25 arranged in eight clusters 35. Another embodiment has 96 cavities 25 arranged in 24 clusters 35.

As illustrated in FIGS. 2, 2A and 3, the shape of the rotor 20 is substantially triangular with a flat base and an annular upper surface. The rotor 20 can be made from aluminum, steel, plastics or other suitable materials. A preferred embodiment is manufactured from aluminum alloy and coated with an epoxy-teflon mixture that resists reaction with laboratory chemicals. However, the material, size and general shape of the rotor may be adjusted for application specific needs.

Each cavity 25 of the centrifuge rotor 20 is sized to accommodate a vessel 45. The vessel 45 typically is a test tube. Other vessels may be substituted. For example, the vessel may be a well in a plate, with the plate having a plurality of sample wells. In such a manner the plate could be received in the rotor. The vessels 45 are capable of undergoing multiple process steps before or after the isolation process. Each of these vessels 45 has a surface that a transporter could use to transfer the vessel 45 to another processing station. These vessels 45 are constructed such that post- and pre-isolation steps may be conducted directly on the material in the vessel 45. The compatibility of the vessel 45 with other processing steps performed prior to or after the isolation process eliminates increased production costs incurred from transferring material from one vessel 45 to a second or third vessel 45, and then cleaning and sterilizing the used vessels 45. Further, eliminating one or more transfer steps increases the efficiency of the overall process because of the decreased production time in not having to perform an extra transfer step and the increased yield from not losing any material in a transfer step.

The most common use for a centrifuge is to concentrate or purify materials that are in suspension or dissolved in fluids. The fluid is placed in the vessel 45 with the vessel 45 then placed in the cavity 25. The rotor 20 is then spun by a rotor motor 27 or other suitable device to create a centrifugal force on the fluid inside in the vessel 45. The centrifugal force acts on the objects inside the fluid separating them by their different densities. For example, suspended particles denser than the suspending liquid tend to migrate towards the side of the vessel 45, illustrated in FIG. 4. When the centrifugation process is complete a pellet 50 of the denser material has formed on the side, or bottom of the vessel 45. Illustrated in FIGS. 2, 2A and 4, the cavities 25 are angled relative to the rotor rotational axis 55. Vessel 45, located in the cavity 25 is thereby also angled, which positions the pellet 55 near the bottom of the vessel 45. In a preferred embodiment, this angle is about 32 degrees, but other angles can be employed to locate the pellet 50 in a different location in vessel 45.

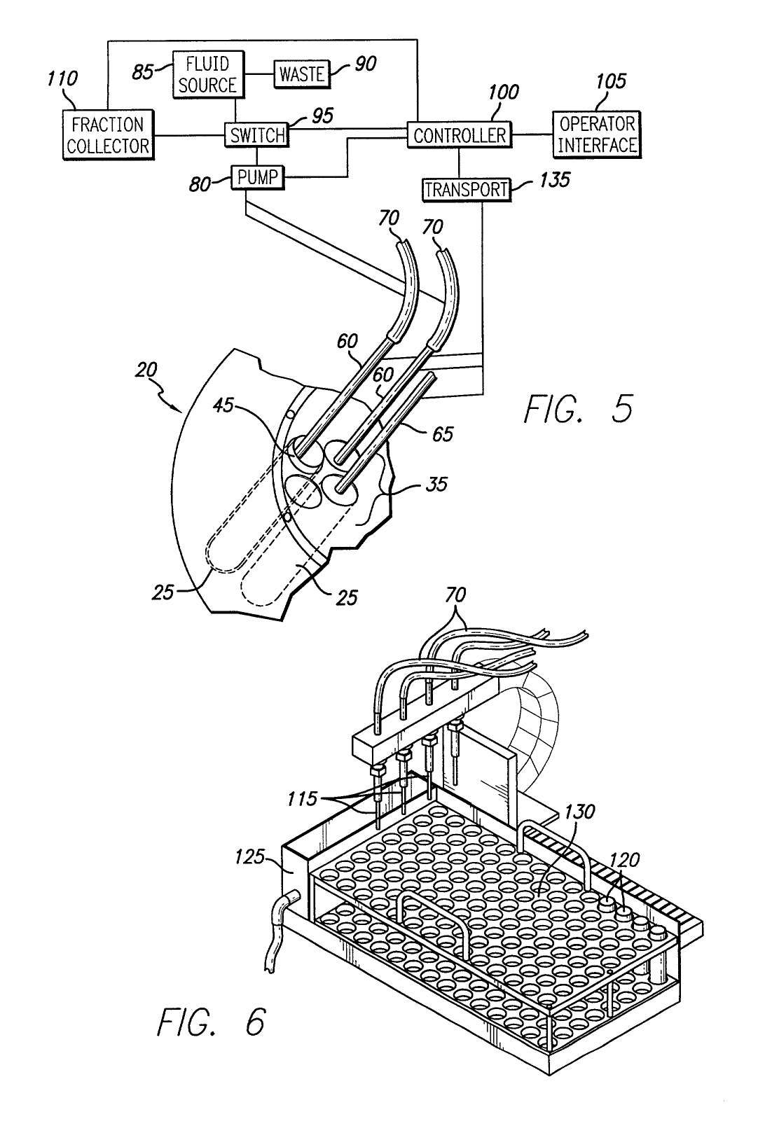

Referring to FIG. 5, a cluster 35 is illustrated with a tube 60 inserted in one cavity 25 containing a vessel 45. Tube 60 is connected to a hose 70 that communicates with pump 80. Fluid source 85, fraction collector 110 and waste deposit 90 communicate with the pump 80 through switch 95. The tube 60 is moved into and out of the cavity 25 by transport 135. Controller 100 also directs the pump 80 and switch 95.

Also illustrated in FIG. 5 is a second tube 60 and a sonication rod 65. In one embodiment the robotic accuator will control four tubes 60 and insert them substantially simultaneously into the cluster 35 of four cavities 25. Because the longitudinal axes of the four cavities 25 are substantially parallel, the four tubes 60 can be inserted substantially simultaneously into the cavities 25. In this manner, tubes 60 can simultaneously dispense fluid from the fluid source 85 or aspirate fluid from the vessel 45 and into the waste dump 90 or into the fraction collector 110. In another embodiment, a sonication rod 65 is coupled with each tube 60 so that sonication can be performed during, before or after aspiration or dispensing of fluid by tube 60. In yet another embodiment, a tube 60 may be inserted in one cavity 25 while a sonication rod 65 may be inserted in a second adjacent cavity 25, and in this manner different steps can be performed simultaneously within each cavity 25. Different combinations of tubes 60 and sonication rods 65 can be employed, with a myriad combination of aspiration/dispense/sonication procedures possible.

The tube 60 is connected by a hose 70 to pump 80 which in a preferred embodiment is a peristatic pump. Other types of pumps can be employed for pumping fluids through the hoses 70. The hoses 70 preferably are made of nylon tubing which resist reaction with laboratory chemicals and the tubes 60 preferably are made of stainless steel, which also resists reaction with laboratory chemicals. In a preferred embodiment, the tubes are made of 316 stainless steel, but the tubes 60 and the hoses 70 can be made of other suitable materials. The sonication rod 65 is made of titanium, but other suitable materials can be used for the sonication rod 65.

Fluid source 85 comprises buffers, washes, cleansers and other fluids and substances necessary for conducting a variety of scientific tests. For example, a variety of buffers, such as Triton X-100, DB (deoxycholate buffer), and GB (guanidine buffer), all manufactured by Sigma-Aldrich Company of St. Louis, Mo., can be employed in the fluid source 85. In a preferred embodiment, up to six different fluids can be employed in the fluid source 85, but more or fewer fluids (as necessary to conduct a specific test) can be used in the fluid source 85.

Waste dump 90 is configured to accept waste fluids from the pump 80. In one embodiment, the waste dump 90 comprises a hose that runs to a container located outside of the automated centrifuge. Alternatively, the waste dump 90 can be a trough located adjacent to the fraction collector 110. Also, a waste dump 90 can be located adjacent to the rotor 20. Switch 95 comprises one or more switches that preferably are electrically driven solenoid valves. In one embodiment, the wetted surfaces in the switches 95 are TEFLON, or TEFLON-coated (TEFLON is a registered trademark of E. I. du Pont de Nemours, a Delaware corporation), but other types of switches having other types of suitable coatings or base materials can also be employed.

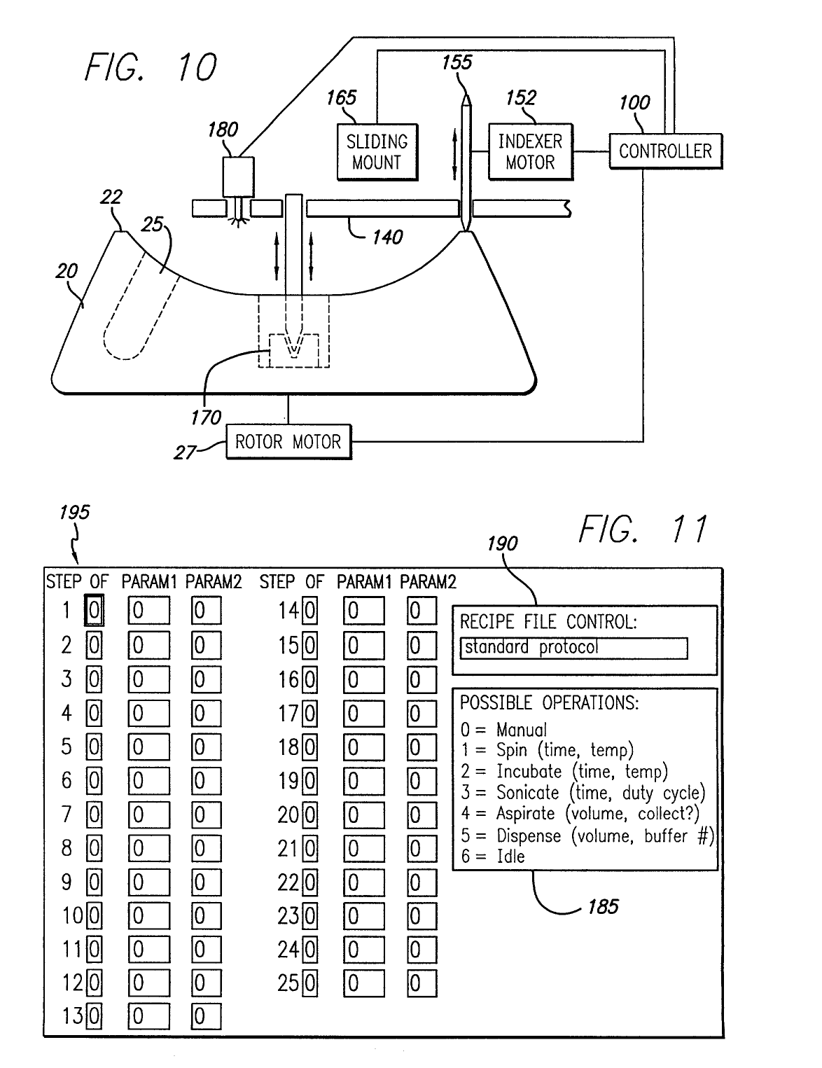

Referring to FIGS. 5 and 10, controller 100 is a general purpose computing device such as a personal computer that controls one or more programmable logic controllers. Other types of general purpose computing devices can be used as a controller 100. In a preferred embodiment, a personal computer using RS VIEW software, manufactured by Allen Bradley, provides an operator interface 105, that directs the controller 100. The controller 100 communicates with the transport 135, pump 80, switch 95, fraction collector 100, and other devices on the automated centrifuge through wires or other suitable means.

Illustrated in FIGS. 5 and 6, fraction collector 110 is connected to switch 95 and to controller 100. The fraction collector 110 comprises hoses 70 connected to one or more pipes 115 which dispense fluid obtained from the vessels 45 into specimen collectors 120 that are located in tray 130. Depending upon the fluid in the hoses 70 and the instruction from the controller 100, the pipes 115 can also dispense fluid into a waste trough 125 located adjacent to the tray 130. The specimen collectors 120 collect material that is obtained from the vessels 45 by tubes 60 after a separation procedure has been completed by centrifugation. The pipes 115 can vary in number depending upon the number of tubes 60 that obtain fluid from the vessels 45. In one embodiment, four pipes 115 correspond to four tubes 60 that are inserted into a cluster 35 containing four vessels 45. The number of pipes 115 can vary depending upon the number of tubes 60 and the number of corresponding cavities 25 in each cluster 35. The pipes 115 communicate with controller 110 and are movable so that they can dispense fluid into any number of specimen collectors 120, where the specimen collectors preferably are in a 96, 384, or 1536 member sample format. In a preferred embodiment, the pipes 115 are mounted on a sliding accuator that is controlled by an electric motor. The pipes 115 can be moved by other means such as hydraulic, pneumatic or other suitable movement devices.

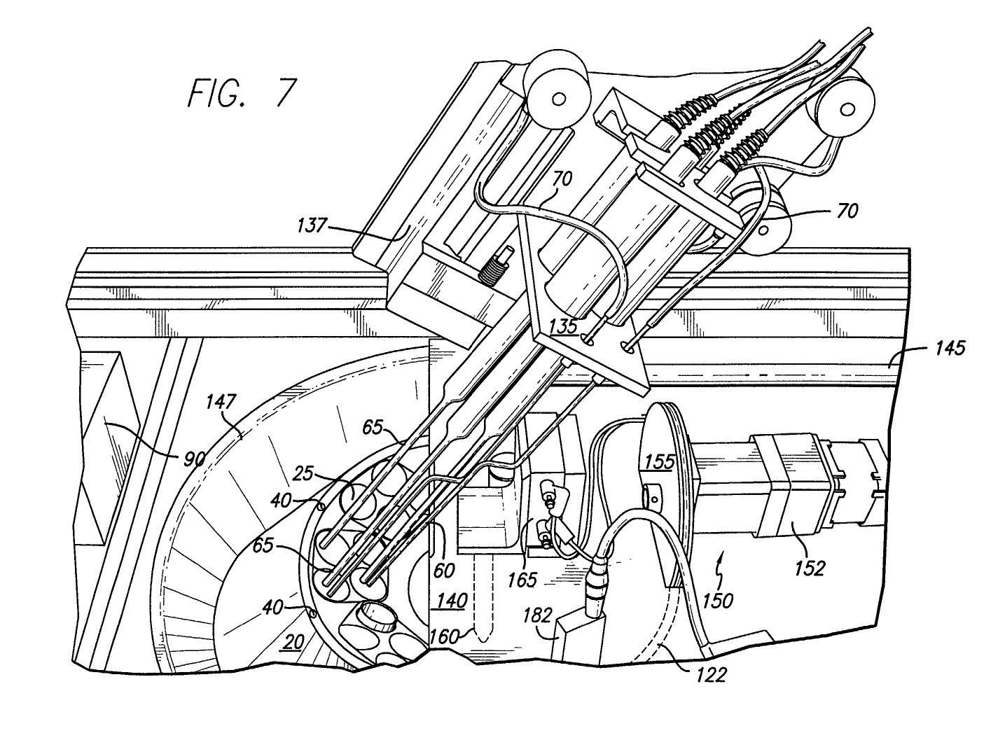

Referring to FIG. 7, one embodiment of the present invention is illustrated. In this embodiment, a rotor 20 having a cluster 35 containing four cavities 25 is configured to be substantially simultaneously inserted with a group of tubes 60 and rods 65 arranged in pairs so that one tube and one rod are inserted into each cavity 25. In this arrangement, each cavity 25 of the cluster 35 can be simultaneously inserted with a tube 60 and rod 65. Transport 135 holds the four tubes 60 and four rods 65, and as discussed above, the tubes 60 are connected to hoses 70 and the rods 65 comprise a sonication device employing a 20 kilohertz transducer. The sonication device re-suspends particles that have been compressed by centrifugation. Other types of re-suspension devices can be employed, such as chemical re-suspenders.

The movable transport 135 is mounted on a pneumatic slide 137 that is actuated by controller 100 to insert and remove the tubes 60 from the cavities 25. In addition to the movement into and out of the cavities 25, the transport 135 can also be moved horizontally by an electric motor that communicates with the controller 100. In this manner, the transport 135 can be moved away from the rotor 20 to permit insertion of vessels 45 into the rotor 20 and removal of the rotor 20 from the centrifuge.

Also, as shown in FIG. 8, one embodiment of the present invention can employ three rotors 20, and transport 135 can be moved into position over each rotor 20 by controller 100 directing the movement of the transport 135. The number of rotors 20 incorporated into an automated centrifuge constructed according to the present invention can vary according to the needs of the laboratory, or research facility. Also shown in FIG. 8, are the operator interface 105, fluid pump 80, and rotor control boxes 200.

Another preferred embodiment employs multiple transports, such as transport 135. With multiple transports 135, each transport 135 can be arranged to simultaneously cooperate with different clusters 35. In such a manner, the same fluid function can be performed on more cavities 25 at the same time, enabling a more efficient operation. Alternatively, each transport 135 can control a group of tubes 61 to perform a single function, which would minimize the need for washing or cleaning the tubes between process steps. For example, one group of tubes 61 may be used to dispense a buffer, another group to aspirate a first fluid, and a third group to aspirate a second fluid. Since each group of tubes 61 has only one function, there is no need to wash or clean the tubes between steps.

Again referring to FIG. 7, rotor cover 140 is slidably positioned over the rotor 20 by actuator 145. In this embodiment, two accuators 145 each comprise a pneumatic piston that communicate with controller 100. Other devices can be used to position the rotor cover 140 over, and away from the rotor 20. The rotor cover 140 has a circumferential seal located on the underside of the rotor cover 140 so that when the rotor cover 140 is positioned over the rotor 20, the seal will engage the rotor housing 147. In one embodiment the seal is comprised of rubber and can be expanded by the injection of air, thereby causing the seal to mate with the rotor housing 147. In this manner, an air-tight seal can be created between the rotor housing 147 and the rotor cover 140 to increase centrifugation efficiency by minimizing the movement of air generated by the spinning rotor 20.

II. Functions of the Automated Centrifuge

With reference to FIGS. 7-11, a description of the discrete functions which the automated centrifuge of the present invention can perform will be described. Illustrated in FIGS. 8 and 11, the operator interface 105 allows a technician to program the controller 100 with a “recipe” which is a list of instructions that tells the controller 100 to perform specific functions appropriate to a specific test. FIG. 11 illustrates a recipe entry screen. In the illustrated embodiment, up to 25 separate steps can be performed in one recipe. More or less than 25 steps can comprise a recipe, depending upon the requirements of a specific test. Once the specific step 195 has been chosen by the technician, a corresponding function is chosen from the possible operations box 185. Once the recipe is finished and all of the steps 195 have been entered by the technician, the recipe can be named and saved in the recipe file control box 190. In this manner, hundreds of discrete recipes can be stored for easy access to quickly program the present invention thereby saving valuable technician time.

Generally, the first step is to load the vessels 45, containing a solution for centrifugation, into cavities 25. This can be performed either manually or with the indexer 150 engaged. Illustrated in FIGS. 7, 9 and 10, the indexer 150 comprises a wheel 155 that is positioned to contact the rotor rim 22. The wheel 155 is driven by an indexer motor 152 that communicates with controller 100. The indexer motor 152 and wheel 155 are slidably mounted on the rotor cover 140 by a pneumatically driven slide that communicates with controller 100. In manual mode, the controller 100 instructs the pneumatically driven slide to raise the wheel 155 away from the rotor rim 22, so that the rotor 20 can be easily spun by hand. In this manner, the rotor 20 can be rotated and vessels 45 can be placed into cavities 25. Alternatively, the rotor 20 can be loaded with vessels 45 by configuring the present invention into index mode. In index mode, the indexer 150 is lowered by the controller 100 so that wheel 155 directly contacts the rotor rim 22. To keep the rotor 20 from tilting when the wheel 155 engages the rotor rim 22, a live center 160 is inserted into the rotor post 170, shown in FIG. 10. The live center 160 is connected to sliding mount 165 which communicates with controller 100. The sliding mount is pneumatically driven, but other devices can be used to raise and lower the sliding mount 165 to disengage or engage the live center 160. Other devices can also be used to raise and lower the indexer 150 and wheel 155. When the indexer motor 152 is lowered, with the wheel 155 contacting the rotor rim 22, the controller 100 searches for the first cluster 35. This is accomplished by two optical sensors 180 and 182 that communicate with controller 100 and are mounted on rotor cover 140.

Referring to FIGS. 7, 9 and 10, a reference optical sensor 180 detects a designated first cluster 35, and a rim optical sensor 182 detects all of the clusters 35 by reading indexes 40 on the rotor rim 22. The rim optical sensor 182 reads the indexes 40 and the controller 100 then positions the appropriate cluster 35 that corresponds to each index 40 under the tubes 60. In a preferred embodiment, the reference optical sensor 180 detects a reference located on the rotor 20 that indicates a first cluster 35. Once the first cluster 35 is located, the index wheel 55 rotates the rotor 20 one cluster 35 at a time by using the rim optical sensor 182, which reads the indexes 40 located on the rotor rim 22. In this manner, the first cluster 35 can be determined and each subsequent cluster 35 can be positioned underneath the tubes 60 and rods 65. Other suitable sensors and methods can be employed to determine the location of each cluster 35.

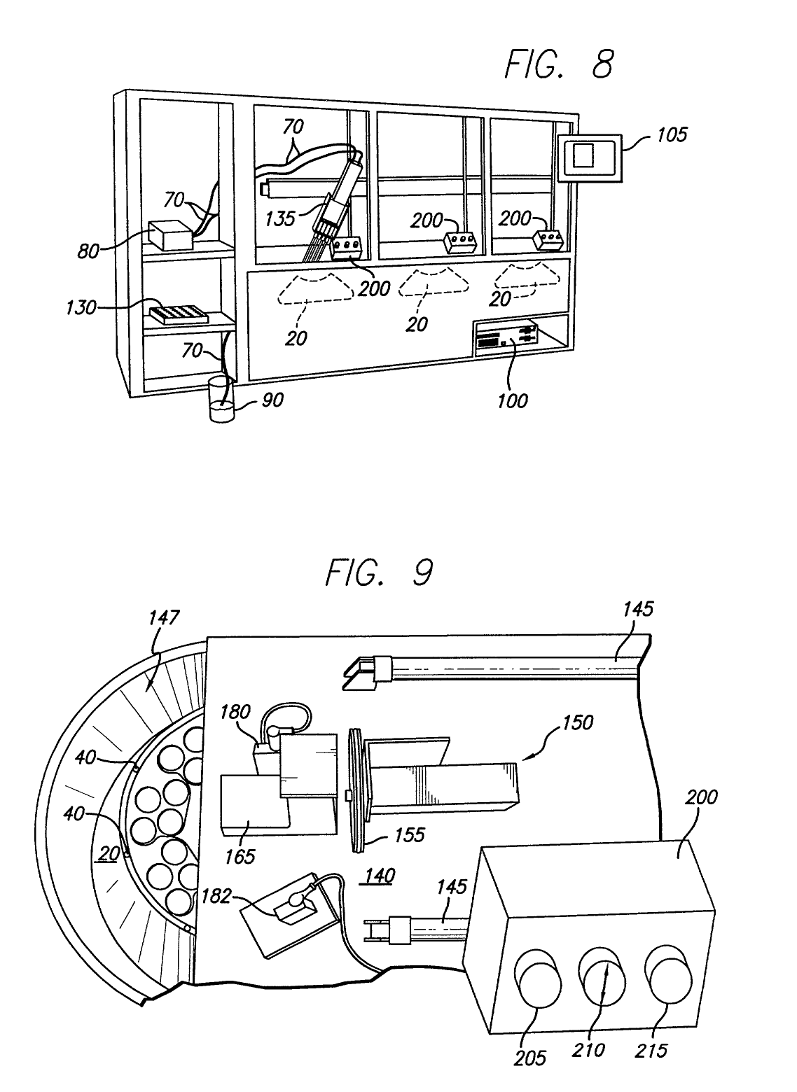

As described above, when the present invention is configured in index mode, the rotor 20 is rotated by wheel 155 so that a technician can insert vessels 45 into the cavities 25 without manually turning the rotor 20. Illustrated in FIG. 9, a rotor control box 200 that communicates with controller 100, controls the movement of rotor 20 by the above-described system of optical sensors 180 and 182, indexer motor 152 and wheel 155. The rotor control box 200 comprises a open/close switch 205, a rotor rotation button 210, and an emergency stop knob 215. When in index mode, as described above, the optical sensors 180 and 182, working with indexer motor 152 and wheel 155 position the rotor 20 over a first cluster 35. A technician can then load vessels 45 into the four cavities 25 comprising the first cluster 35. When finished, the technician presses the rotor rotation button 210, rotating the rotor 20 in a clockwise direction so that the next cluster 35 is positioned for insertion of vessels 45. As illustrated in FIG. 9, the rotor rotation button comprises an up-arrow switch that moves the rotor 20 in a clockwise direction and a down-arrow switch that moves the rotor 20 in a counterclockwise direction. When the technician has completed inserting vessels 45 into all of the cavities 25 by rotating the rotor 20 one cluster 35 at a time, the technician activates the open/close switch 205 which instructs the controller 100 to slide the rotor cover 140 over the rotor 20. The rotor control box 200 also includes an emergency stop knob 215 that cuts power to all the electrically driven devices on the present invention in case of an emergency situation.

Another function of the present invention is incubation of components or other materials contained in vessels 45 that are located in the cavities 25. For example, protein isolation and other laboratory procedures can require the incubation of the proteins. Incubation is accomplished by positioning the rotor cover 140 over the rotor 20, inflating the rotor seal, thereby sealing the rotor 20 from the environment. A conventional centrifuge cooling system communicates with the rotor 20 and temperatures can be accurately maintained in a range between minus 10 degrees centigrade to above 50 degrees centigrade. A centrifuge cooling and heating system could also be employed with the present invention.

Yet another function of the present invention is the centrifugation of suspended particles located in vessels 45 that have been placed in the cavities 25. This is accomplished by sealing the rotor 20 from the environment by placing the rotor cover 140 over the rotor 20 inflating the rotor seal and spinning the centrifuge rotor 20 thereby separating the suspended particles by their densities.

Still another function performed by the present invention is the dispensing of buffers, rinses or other fluids into the vessels 45 that have been placed in the cavities 25. Illustrated in FIGS. 5 and 7, the tubes 60 are inserted into the vessels 45 by transport 135 that is being directed by controller 100. Hose 70 connected to tube 60 carries fluid from pump 80 which obtains the fluid from the fluid source 85. Different fluids, such as buffers, washes, or cleansers can be selected from the fluid source 85 by the controller 100 and thereby dispensed by the pump 80 through the hoses 70 and into the tube 60 and finally into the vessels 45. In this manner, various fluids can be dispensed into the vessels 45 as part of a protein isolation or other centrifugation procedure. In the preferred embodiment, shown in FIG. 7, fluid can be dispensed into four vessels 45 substantially simultaneously by the four tubes 60 that are positioned over each cavity 25 in the cluster 35 containing four cavities 25. Only one, or more than four vessels 45 can receive fluid depending upon the number of tubes 60 and the arrangement of cavities 25 in the rotor 20.

Aspiration of fluids from vessels 45 can be performed by the present invention in a manner similar to the dispensing function described above. Tube 60 is inserted into vessel 45 that is located in cavity 25 and pump 80 is activated to create a vacuum thereby sucking out the fluid contained in the vessel 45. The removed fluid travels through the tube 60 into the hose 70 through the pump 80 and can either be sent to fraction collector 110 or to waste dump 90, depending upon the instructions sent by controller 100. For example, after centrifugation, denser material has been forced to the bottom of vessel 45 and the less-dense fluid is aspirated by the tube 60 into the waste dump 90. Alternatively, a soluble protein maybe suspended in the vessel 45 and the soluble protein can be aspirated from the vessel 45 by the tube 60 and sent to fraction collector 110. At the fraction collector 110, the soluble protein fluid is deposited into specimen collectors 120. As discussed above, and illustrated in FIG. 7, aspiration of up to four vessels 45 can be conducted substantially simultaneously by the present invention, drastically reducing the time required for laboratory experiments. The number of vessels 45 that can be aspirated, however, can be varied depending upon the arrangement of tubes 60, and the instructions sent by controller 100.

An additional function performed by the present invention is the sonication of materials located in the vessel 45. When one or more vessels 45 are chosen for sonication, the sonication rod 65 is inserted into the vessel 45 and the controller 100 activates the sonicator. During sonication the rod is vibrated at a frequency of about 20 kilohertz. Other frequencies can be employed for sonication. This creates sound waves which break apart the material located in the vessel. For example, once an initial centrifugation step has been performed, a collection of cells will be located near the bottom of the vessel 45. The sonication rod 65 is inserted into the vessel 45 and the cells are sonicated, which breaks the cells apart thereby exposing the proteins which are later isolated. In a preferred embodiment, as illustrated in FIG. 7, a sonication rod 65 is positioned adjacent to a aspirate/dispense tube 60. In this manner, sonication can be performed immediately after, before or during the dispensing or aspiration of fluids from the vessel 45.

A sample recipe will now be described thereby illustrating one possible automated isolation process which can be performed by the present invention. Vessels 45 containing suspended material are placed in the cavities 25 in the rotor 20. The controller 100 then moves the rotor cover 140 over the centrifuge rotor 20 and the rotor 20 is spun by rotor motor 27. The rotor cover 140 is then slid back revealing the vessels 45. The transport 135 moves the tubes 60 and rods 65 into position over the first cluster 35 found by the optical sensors 180 and 182. Four tubes 60 are substantially simultaneously inserted into the four vessels 45 and the fluid located therein is aspirated into the waste dump 90. The tubes 60 are removed by the transport 135, the indexer 150 rotates the index wheel 155 to the next cluster 35 and this procedure is repeated until all of the fluid in all of the vessels 45 is removed.

The vessels are then removed by a technician and frozen which breaks up many of the cells located in the pellet which has formed in the bottom of the vessel 45 as a result of the centrifugation. After freezing, the vessels 45 are again loaded into the cavities 25 in the rotor 20. The controller 100 then instructs the transport 135 to position the tubes 60 into the vessels 45 and a selected buffer is dispensed into each vessel 45. Also, the sonication rod 65 is simultaneously inserted with the tube 60 and the pellet is sonicated, thereby disbursing the components of the pellet into the buffer fluid. This fluid dispensing and sonication procedure is performed on all the vessels 45 that are contained in the rotor 20.

The rotor cover 140 is then positioned over the rotor 20 and the rotor and vessels 45 are incubated. The rotor cover 140 is then slid away from the rotor 20 and the sonication rods 65 are inserted into the vessels 45 and activated resuspend the cells. The sonication rods 65 are removed by the transport 135, the rotor cover 140 is positioned over the rotor 20, and the rotor 20 is then spun to centrifuge the materials contained in the vessels 45.

Now, tubes 60 are inserted into the vessels 45 and the fluid is aspirated out into the fraction collector 110. The material aspirated may contain soluble proteins as part of a protein isolation procedure. After depositing the fluid into the fraction collector 110, the hoses 70 can be rinsed by flushing fluid from the fluid source 85 through the hoses 70 and through the tubes 60 into waste dump 90 located adjacent to the centrifuge rotor 20. After the flushing procedure, the controller 100 activates the pump 80 to aspirate the rinsing solution into the waste dump 90. Tubes 60 are now inserted into the vessels 45 and a selected buffer from the fluid source 85 is inserted into the vessels 45. The sonication rod 65 is then activated, sonicating the recently dispensed buffer and the materials still remaining in the vessels 45. The tube 60 and rod 65 are removed from the vessel 45 and the rotor 20 is spun centrifuging the fluid. The tube 60 is again inserted into the vessel 45 and the fluid is aspirated into the waste dump 90 by pump 80.

This process of dispensing buffer, sonicating, centrifuging and aspirating waste fluid can be repeated as many times as necessary to further purify the remaining proteins left after centrifugation. In one recipe, the remaining insoluble proteins located in the vessel 45 can be dissolved by using tube 60 to dispense a buffer designed to place the insoluble proteins into solution, such as GB buffer, described above. Again, these materials are sonicated either during dispensing of the buffer or shortly thereafter. They are also centrifuged and the remaining fluid is aspirated by the tube 60. The fluid aspirated is deposited into the fraction collector 110 and into specimen collectors 120. The order of dispensing fluid, sonicating, incubating, aspirating can be changed or varied depending upon the requirements of each test.

III. An Alternative Automated Centrifuge System

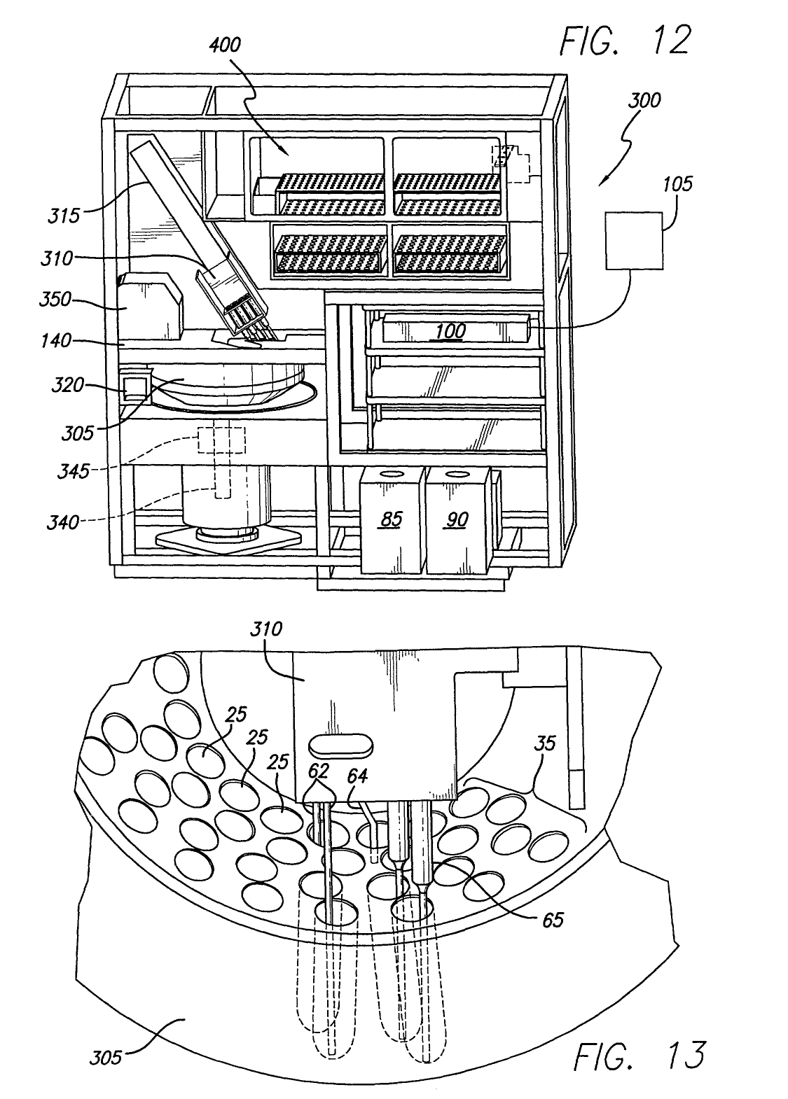

Referring to FIG. 12, an alternative embodiment automated centrifuge system 300 is shown. In this embodiment, the automated centrifuge system 300 comprises a large rotor 305 containing a plurality of clusters 35 of cavities or holes 25 arranged to cooperate with aspirate tubes 62, dispense tubes 64 and rods 65, shown in FIG. 13. The tubes 62 and 64 and rods 65 are mounted on a moveable head 310 that rides on a track 315. The moveable head 310 can position the tubes 62 and 64 and rods 65 into or adjacent to the cavities 25. When inserted into the cavities 25, the aspirate tubes 62 can aspirate fluids from one cluster 35 of cavities 25 while the rods 65 sonicate fluid in a second cluster 35 of cavities 25. The dispense tubes 64 are arranged to dispense fluid into the second cluster 35 of cavities 25. In a preferred embodiment, the aspiration and sonication operations can occur substantially simultaneously. The aspiration, sonication and dispense operations can be performed substantially simultaneously, or in any order necessary to efficiently process fluid samples. In this manner, the efficient automated processing of a large number of discrete fluid samples can be performed without substantial human intervention.

The automated centrifuge system 300 illustrated in FIG. 12 eliminates many components of the above-described automated centrifuge system 10, resulting in the faster processing of fluids or substances deposited in the cavities 25. While employing many of the concepts and components of the automated centrifuge system 10, described in detail above, the automated centrifuge 300 eliminates many components, resulting in a machine that processes fluid samples faster, yet costs less to construct and operate. In particular, the indexing system for determining the position of the rotor 20 and the rotor control box 200 is removed from the embodiment illustrated in FIG. 12. The automated centrifuge system 300 employs a rotor position sensor 345. This replaces several components including: index 40, indexer 150, index motor 152, index wheel 155, live center 160, sliding mount 165, reference optical sensor 180 and rim optical sensor 182.

In a preferred embodiment, the rotor position sensor 345 is a rotary optical encoder. Other types of devices used for measuring the rotation and position of a rotor shaft 340 can be employed, such as inductive angle measuring devices, resolvers and other similar apparatus. The rotor position sensor 345 is positioned on the rotor shaft 340 and communicates with the controller 100 which is operated through the operator interface 105. As discussed above, the operator interface 105 allows a technician to program the controller 100 with a “recipe” which is a list of instructions that tells the controller 100 to perform specific functions appropriate to a specific task. For example, a component such as a protein that is suspended in a fluid may need to isolated through a centrifugation process. The technician would program the appropriate “recipe” into the controller 100 and then proceed to load vessels 45 into the large rotor 305.

Referring to FIG. 12, once a recipe has been entered through the operator interface 105 and into the controller 100, the controller 100 determines the position of the rotor 305 through the rotor position sensor 345. The technician inserts vessels 45 into the cavities 25 and then places both hands on the switch 320. The rotor 305 is then rotated presenting a new cluster 35 of cavities 25 for loading. The switch 320 provides an important safety feature by forcing the technician to place his hands on the switch 320 before the rotor 305 is rotated. This avoids any possible injury to the technician by keeping his hands away from the rotating rotor 305. In a preferred embodiment, the switch 320 comprise one or more touch buttons. Touch buttons register an operators touch, converting that touch into an electrical output that signals the controller 100 to rotate the rotor 305. Other types of safety switches such as capacitive and photoelectric sensors and other suitable devices can be employed in place of the switch 320.

After placement of vessels 45 into the cavities 25 the rotor cover 140 is positioned over the rotor 305. The rotor 305 is then spun, separating the different components through a centrifugation process. When the centrifugation process is complete, the rotor 305 is stopped. The controller 100 then instructs the rotor cover 140 to slide away, revealing the rotor 305.

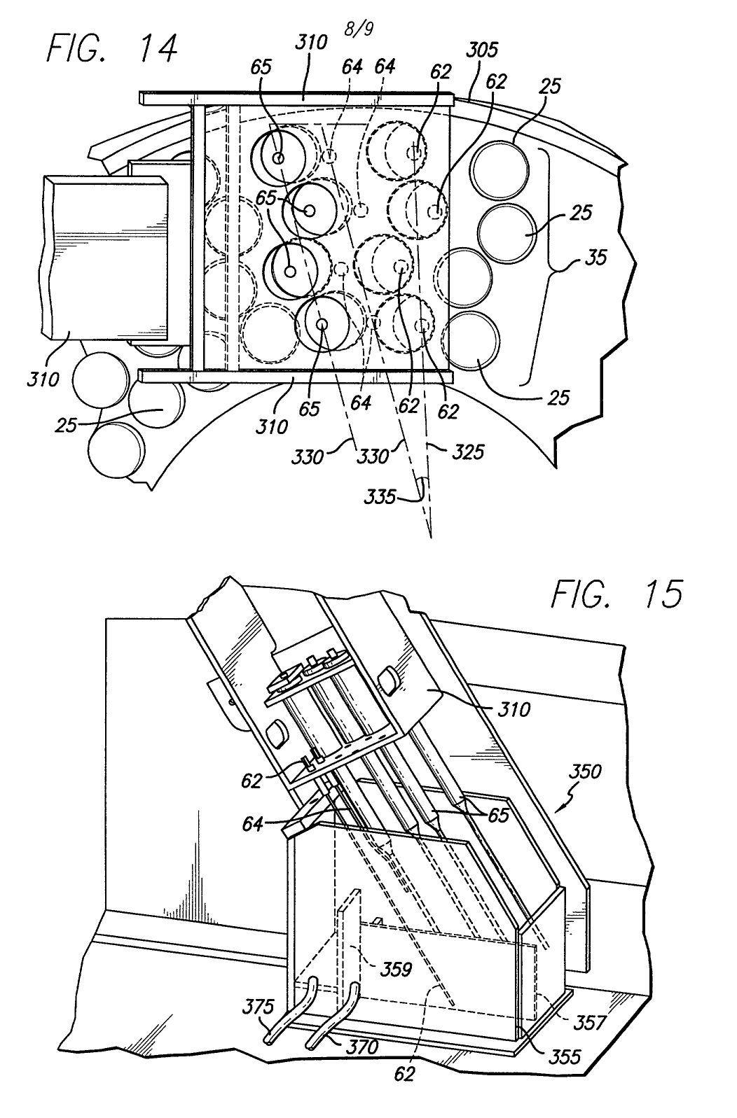

Referring now to FIGS. 13-14, the insertion of the aspirate tubes 62, dispense tubes 64, and rods 65 into the cavities 25 will now be described. In a preferred embodiment, rotor 305 contains 96 cavities 25 arranged in twenty-four clusters 35 of four cavities 25. As shown in FIG. 14, the cavities 25 are arranged substantially radially on the rotor 305. As discussed above, the longitudinal axes of all of the cavities 25 of each cluster 35 are substantially parallel thereby permitting the substantially simultaneous insertion of one or more of the rods 65, aspirate tubes 62 or dispense tubes 64.

Referring to FIG. 14, one arrangement of rods 65 and tubes 62 and 64 is illustrated. Four aspirate tubes 62 and four dispense tubes 64 and four rods 65 are mounted on movable head 310. In a preferred embodiment the dispense tubes 64 and rods 65 have parallel tube axes 325. The rods 62 are arranged on a rod axis 330 that is angled 335 relative to the aspirate tube axis 325. The angle 335 allows the aspirate tubes 62 and rods 65 to be substantially simultaneously inserted into two adjacent clusters 35. This allows the aspiration of fluids from one cluster 35 of cavities 25 and the simultaneous sonication of an adjacent cluster 35 of cavities 25. Shown in FIG. 13, the dispense tubes 64 are significantly shorter than the aspirate tubes 62 and can be arranged to dispense fluid into the same cavities 25 that the rods 65 are positioned in. Other arrangements of tubes 62 and 64 and cavities 25 can be constructed, such as positioning the tubes 62 and rods 65 in a splayed arrangement so that three or more clusters 35 of cavities 25 can be substantially simultaneously serviced.

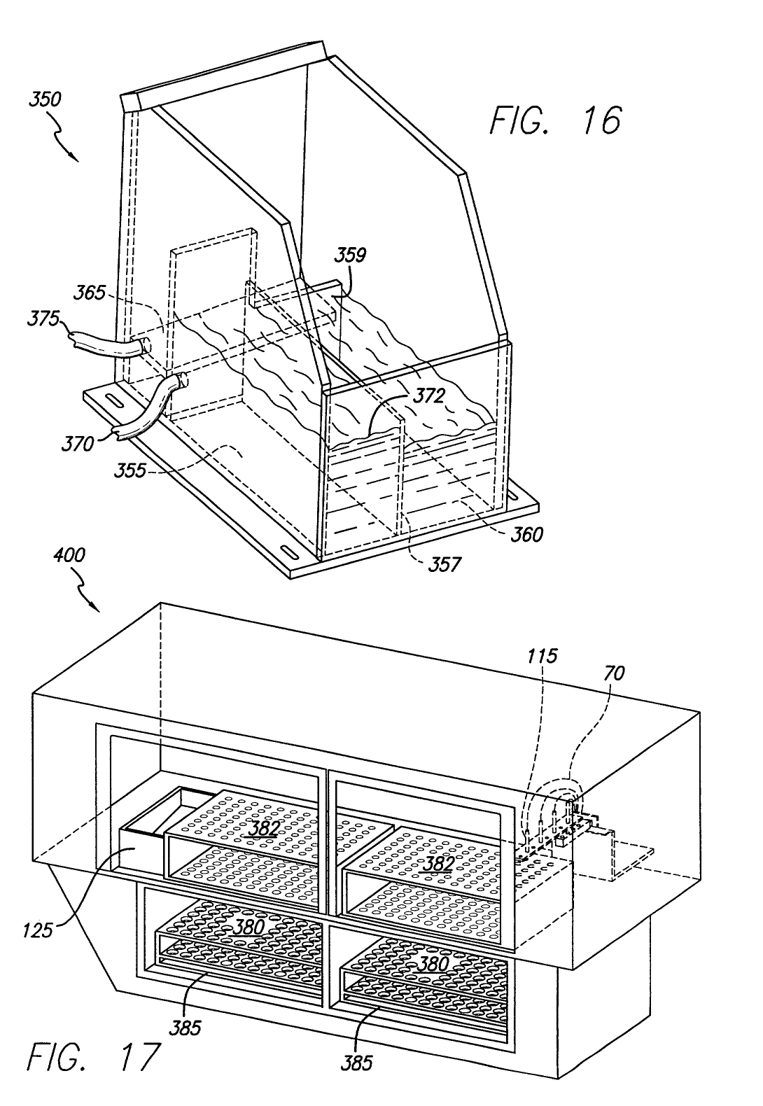

Referring to FIGS. 15-16, a waste/rinse container 350 is illustrated. After the tubes 62 and 64 and rods 65 have performed their functions in the cavities 25, the rotor cover 140 is slid over the rotor 305. This positions the waste/rinse container 350 under the movable head 310. The moveable head 310 is then transported down track 315 and the tubes 62 and 64 and rods 65 are positioned in the waste/rinse container 350. Aspirate tubes 62 are inserted into the tube bin 355 with the rods 65 inserted into the rod bin 360. The dispense tube 64 does not need rinsing as it never contacts any fluids or other substances in the cavities 25. Fluid source 85 delivers fluid through the rinse fluid input 37 and into the tube bin 355. The rinse fluid 372 can be dionized water, alcohol, detergent, or any other suitable rinsing fluid. The rinse fluid 372 washes the aspirate tube 62 and, if necessary, the aspirate tubes 62 can aspirate the rinse fluid 372 and dump it into the waste dump 90. The rinse fluid 372 fills the tube bin 355 and then overflows into the rod bin 360 where it rinses the sonication rod 65. The dispense tube 64 can dispense fluids into the rinse fluid 372 which then runs down the run-off ramp 365 to the rinse fluid exit 375 and to the waist dump 90 through tubes or other means that are not illustrated.

Referring to FIG. 17, a fraction collector 400 is illustrated. The fraction collector 400 is structured to collect the components that have been isolated during the centrifugation process. Pipes 15 that are connected to hoses 70 deposit isolated material obtained from the cavities 25 by the aspirate tubes 62 into a filter bed 382, preferably arranged in a 96, 384, or 1536 member sample format. Hoses 70 communicated with the aspirate tubes 62 as described above. In a preferred embodiment the filter bed 382 comprises a plurality of vessels each containing a filter structured to remove the particles that have not been separated during the centrifugation process. For example, nitrocellulose filters or Whatman filters or sepharose resin filters or other suitable filters can be employed. After passing through the filter bed 382 the fluid then drops down onto resin bed 380, which preferably is arranged in a 96, 384, or 1536 member sample format. Resin bed 380 is structured to catch the components that have been isolated during the centrifugation process. For example, proteins that have passed through the filter bed 382 are now caught in the resin bed 380. In a preferred embodiment, a nickel chelate resin is employed, but other types of resins such as ion-exchange resins and hydrophobic interaction resins can be employed. Located beneath the resin bed 380 is catch tray 385 that catches any remaining fluids and deposits them in waste dump 90.

Also shown in FIG. 12 is controller 100. As discussed above, the controller 100 comprises a general purpose computing device that controls the function of the automated centrifuge 300. In a preferred embodiment, the automated centrifuge 300 employs controller 100 that comprises two programmable logic controllers (PLCs) with one PLC operating the operator interface 105 and directing the second PLC to perform the variety of functions of the automated centrifuge 300.

One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description are also within the scope of the present invention.

What is claimed is:

1. An automated centrifuge system comprising:
a rotor;
a cavity located in the rotor;
a tube structured to be insertable into the cavity;
a transport coupled to the tube; and
a controller communicating with the transport, the controller directing the transport to insert the tube into the cavity.

2. The automated centrifuge system of claim 1, further including a group of cavities located in the rotor, each cavity being substantially parallel to the other cavities in the group.

3. The automated centrifuge system of claim 1, wherein the tube an aspirate tube or a dispense tube.

4. The automated centrifuge system of claim 1, further including a vibrating member that is structured to be insertable into the cavity, the vibrating member being coupled to the transport.

5. The automated centrifuge system of claim 4, wherein the vibrating member is a sonication rod.

6. The automated centrifuge system of claim 1, wherein the tube is deflectable.

7. An automated centrifuge system comprising:
a cluster of holes located in a rotor;
a group of tubes configured to be received into the cluster of holes;
a transport operably coupled to the group of tubes; and
a controller that directs the transport to insert the group of tubes into the cluster of holes.

8. The automated centrifuge system of claim 7, wherein the controller is configured to control the rotor.

9. The automated centrifuge system of claim 7, further comprising an index, wherein the controller uses the index to position the cluster of holes relative to the set of tubes.

10. The automated centrifuge system of claim 7, further comprising:
a second rotor, the second rotor including a cluster of holes; and
a movable platform coupled to the transport; wherein the movable platform moves the transport to selectively position the group of tubes for insertion into the cluster of holes in the rotor and into the cluster of holes in the second rotor.

11. An automated centrifuge comprising:
a group of movable tubes, each tube structured to transport a liquid;
a cluster of rotor holes located in a rotor, the cluster of rotor holes arranged to receive the group of movable tubes; and
a transport holding the movable tubes and constructed to substantially simultaneously move the group of tubes into the cluster of rotor holes.

12. The automated centrifuge according to claim 11, wherein the group of movable tubes consists of four tubes.

13. The automated centrifuge according to claim 11, wherein the cluster of rotor holes consists of four holes.

14. The automated centrifuge according to claim 11, further including a processor for automatically directing the movement of the transport.

15. The automated centrifuge according to claim 11, wherein the cluster of rotor holes are constructed to be substantially parallel.

16. The automated centrifuge according to claim 11, wherein at least one of the movable tubes is constructed to aspirate.

17. The automated centrifuge according to claim 11, wherein at least one of the movable tubes is constructed to dispense.

18. The automated centrifuge according to claim 11, wherein the group of movable tubes further includes a sonication member positioned to be received into one of the rotor holes.

19. The automated centrifuge according to claim 11, wherein the movable tubes are constructed to selectively aspirate and dispense.

20. The automated centrifuge according to claim 11, wherein the group of movable tubes is arranged in pairs of movable tubes, so that when the group of movable tubes is moved into the cluster of rotor holes, one pair of movable tubes is inserted into an associated hole.

21. The automated centrifuge according to claim 11, wherein there are between about two and about ten rotor holes in the cluster of rotor holes.

22. The automated centrifuge according to claim 11, wherein the rotor further includes an index for positioning the cluster of rotor holes relative to the group of movable tubes.

23. The automated centrifuge according to claim 11, further including a second transport holding a second group of movable tubes.

24. The automated centrifuge according to claim 11, further comprising a rotor cover.

25. The automated centrifuge according to claim 11, further comprising one or more pipes, one or more hoses, a pump, a fluid source, a fraction collector, a switch and a waste dump.

26. A method of automated centrifugation, the method comprising the steps of:
placing a vessel in a centrifuge rotor cavity;
substantially isolating a majority of a component located in the vessel by centrifugation; and
re-suspending a majority of the component while the vessel is located in the centrifuge rotor cavity.

27. The method of automated centrifugation of claim 26, further including the step of removing a material from the vessel while the vessel is located in the centrifuge rotor cavity.

28. The method of automated centrifugation of claim 26, further including the step of sonicating a majority of the component while the vessel is located in the centrifuge rotor cavity.

29. The method of automated centrifugation of claim 26, wherein the step of re-suspending the component comprises adding a fluid to the vessel while the vessel is located in the centrifuge rotor cavity.

30. The method of automated centrifugation of claim 28, further including the step of removing a material from the vessel while the vessel is located in the centrifuge rotor cavity, and depositing the material into a specimen collector.

31. A method of automated centrifugation comprising the steps of:
arranging a cluster of cavities on a centrifuge rotor, each cavity configured to receive a sample;
inserting a set of elongated tubes into the cluster of cavities, wherein each tube holds a liquid and is inserted into a corresponding cavity; and
centrifuging the liquid and the sample.

32. The method of centrifugation of claim 31, further including the step of re-inserting the set of elongated tubes into the cavities to remove a portion of the liquid from each cavity.

33. The method of centrifugation of claim 31, wherein the cluster of cavities comprises at least four substantially parallel cavities.

34. The method of centrifugation of claim 31, wherein the set of automated elongated tubes is arranged so that when the set of automated elongated tubes is inserted into the cluster of cavities, at least one elongated tube is inserted into each cavity.

35. The method of centrifugation of claim 31, further comprising the step of positioning the cavities relative to the automated elongated tubes by using a reference index.

36. The method of centrifugation of claim 31, further including the step of removing at least part of the liquid from the cavities, and depositing the liquid into a specimen collector.

37. A centrifuge rotor comprising a cluster of holes located in the centrifuge rotor, each hole including a longitudinal axis; wherein the longitudinal axes of the cluster of holes are substantially parallel.

38. The centrifuge rotor of claim 37, wherein the rotor includes a plurality of clusters of holes.

39. The centrifuge rotor of claim 37, wherein there are between about two and about ten holes in the cluster of holes.

40. The centrifuge rotor of claim 37, wherein there are between about 10 and about 200 holes located in the rotor.

41. The centrifuge rotor of claim 37, wherein each cluster of holes has four holes, and there are between about 8 and about 40 clusters of holes.

42. A centrifuge rotor comprising a cluster of holes located in the centrifuge rotor; wherein the cluster of holes is arranged to substantially simultaneously receive a group of movable tubes held by a transport, wherein each of the movable tubes is structured to transport a liquid.

43. An automated centrifuge system comprising:
a rotor including a plurality of clusters of holes, each hole including a longitudinal axis, each cluster having holes with substantially parallel longitudinal axes;
a plurality of tubes arranged in at least two groups, with each group of tubes configured to be received into an adjacent cluster of holes;
a transport operably coupled to the groups of tubes; and
a controller that directs the transport to insert the groups of tubes into the adjacent clusters of holes.

44. The automated centrifuge system of claim 43, further including a plurality of rods arranged in a group, with the group rods configured to be positioned into a cluster of holes.

45. The automated centrifuge system of claim 43, wherein the two groups of tubes are arranged along first and second tube axes, so that the first tube axis is angled with respect to the second tube axis.

46. The automated centrifuge system of claim 45, further including a plurality of rods arranged along a rod axis, with the rod axis angled with respect to at least one of the first and second tube axes.

47. The automated centrifuge system of claim 43, further including a plurality of rods arranged along a rod axis, the rods configured to be received into a cluster of holes; wherein the two groups of tubes are arranged along first and second tube axes, so that the first tube axis is substantially parallel to the rod axis, but the first tube axis is angled with respect to the second tube axis.

48. The automated centrifuge system of claim 43, wherein one group of tubes are aspirate tubes and a second group of tubes are dispense tubes.

49. The automated centrifuge system of claim 44, wherein the plurality of rods are sonication rods.

50. The automated centrifuge system of claim 43, wherein there are four holes in each cluster of holes and there are between about 8 and about 40 clusters of holes.

51. The automated centrifuge system of claim 43, wherein the two groups of tubes comprise four tubes each, wherein one group of tubes is configured to aspirate, and the other group of tubes is configured to dispense.

52. The automated centrifuge system of claim 43, further comprising a rotor position sensor.

53. The automated centrifuge system of claim 52, wherein the rotor position sensor is a rotary optical encoder.

54. A method of automated centrifugation, the method comprising the steps of:
placing a plurality of vessels in a plurality of centrifuge rotor cavities;
substantially isolating a majority of a component located in each vessel by centrifugation;
re-suspending the majority of the component in a first group of vessels; and
substantially simultaneously dispensing a substance into a second group of vessels.

55. The method of automated centrifugation of claim 54, wherein the steps of re-suspending the majority of the component and substantially simultaneously dispensing a substance into a second group of vessels are performed when the vessels are located in the centrifuge rotor cavities.

56. The method of automated centrifugation of claim 54, further including the steps of removing the component from the vessels while the vessels are located in the centrifuge rotor cavities, and depositing the component into a specimen collector.

57. The method of automated centrifugation of claim 56, wherein the specimen collector is selected from the group consisting of: a filter, a nitrocellulose filter, a vessel, a resin, a resin bed, an ion-exchange resin and a hydrophobic interaction resin.

58. An automated centrifuge system comprising:
a rotor including a plurality of clusters of holes, each hole including a longitudinal axis, each cluster having holes with substantially parallel longitudinal axes;
a plurality of tubes arranged in at least two groups, with each group of tubes configured to be received into adjacent clusters of holes;
a rotor position member structured to determine the position of each cluster of holes;
a transport operably coupled to the groups of tubes; and
a controller that directs the transport to insert and remove the groups of tubes into the adjacent clusters of holes, and directs the rotor position member to rotate the rotor to another cluster of holes.

59. The automated centrifuge system of claim 58, further including an operator safety member that communicates with the controller, and directs the rotor position member to rotate the rotor when contacted by the operator.

60. The automated centrifuge system of claim 59, wherein the operator safety member is selected from the group consisting of: a switch, a button, and a touch button.

61. The automated centrifuge system of claim 58, further including a rinse container structured to contain a fluid and moveably positioned adjacent to the plurality of tubes; wherein the controller positions the tubes in the rinse container for selectively depositing waste fluid and rinsing the plurality tubes.

62. The automated centrifuge system of claim 61, wherein the rinse container comprises a tube bin, a rod bin and a runoff ramp.

63. An automated centrifuge comprising:
means for placing a plurality of vessels in a plurality of centrifuge rotor cavities;
means for substantially isolating a majority of a component located in each vessel by centrifugation;
means for re-suspending a majority of the component in a first group of vessels; and
means for substantially simultaneously dispensing a substance into a second group of vessels.

64. The automated centrifuge of claim 63, wherein the means for re-suspending the majority of the component and the means for substantially simultaneously dispensing a substance into a second group of vessels are capable of performing their functions when the vessels are located in the centrifuge rotor cavities.

65. The automated centrifugation of claim 63, further including means for removing the component from the vessels while the vessels are located in the centrifuge rotor cavities, and means for depositing the component into a specimen collector.

66. The automated centrifuge of claim 65, wherein the specimen collector is selected from the group consisting of: a filter, a nitrocellulose filter, a vessel, a resin, a resin bed, an ion-exchange resin and a hydrophobic interaction resin.

67. A centrifuge rotor comprising:
a rotor body defining a plurality of cavities into which vessels containing material to be centrifuged may be removeably positioned, the plurality of cavities being positioned in two of more clusters about the rotor body, each cluster comprising at least two cavities which are oriented relative to each other such that longitudinal axes of the cavities in the cluster are parallel with each other.

68. A centrifuge rotor according to claim 67 wherein the rotor body comprises 2, 3, 4, 5, 6, 7, 8 or more clusters.

69. A centrifuge rotor according to claim 67 wherein each cluster comprises 2, 3, 4, 5, 6, 7, 8, 9, 10, 11, 12, 13, 14, 15, 16 or more cavities whose longitudinal axes are parallel with each other.

70. A centrifuge rotor according to claim 67 wherein each cavity is capable of housing a vessel having a volume of at least 10 mL.

71. A centrifuge rotor according to claim 67 wherein each cavity is capable of housing a vessel having a volume of at least 25 mL.

72. A centrifuge rotor according to claim 67 wherein each cavity is capable of housing a vessel having a volume of at least 50 mL.

73. A centrifuge rotor according to claim 67 wherein each cavity is capable of housing a vessel having a volume of at least 75 mL.

74. A centrifuge rotor according to claim 67 wherein each cavity is capable of housing a vessel having a volume of at least 100 mL.

75. An automated centrifuge system comprising:
a centrifuge rotor for use with a centrifuge, the centrifuge rotor comprising a rotor body defining a plurality of cavities into which centrifuge vessels containing material to be centrifuged may be removeably positioned, the plurality of cavities being positioned in two of more clusters about the rotor body, each cluster comprising at least two cavities which are oriented relative to each other such that longitudinal axes of the cavities in the cluster are parallel with each other; and
a robot capable of positioning a plurality of the centrifuge vessels into a plurality of cavities in a same cluster of the centrifuge rotor at the same time.

76. An automated centrifuge system according to claim 75 wherein the robot is capable of positioning at least 2 centrifuge vessels into cavities in a same cluster of the centrifuge rotor at the same time.

77. An automated centrifuge system according to claim 75 wherein the robot is capable of positioning at least 4 centrifuge vessels into cavities in a same cluster of the centrifuge rotor at the same time.

78. An automated centrifuge system according to claim 75 wherein the robot is capable of positioning at least 8 centrifuge vessels into cavities in a same cluster of the centrifuge rotor at the same time.

79. An automated centrifuge system according to claim 75 wherein the robot is capable of positioning at least 16 centrifuge vessels into cavities in a same cluster of the centrifuge rotor at the same time.

80. An automated centrifuge system according to claim 75 wherein the robot is capable of positioning at least 32 centrifuge vessels into cavities in a same cluster of the centrifuge rotor at the same time.

81. An automated centrifuge system according to claim 75, the system further comprising logic for controlling a reorientation of the centrifuge head relative to the robot such that the robot is capable of positioning centrifuge vessels into cavities of different clusters of the centrifuge rotor.

82. An automated centrifuge system according to claim 75, the system further comprising logic for tracking which centrifuge vessels are positioned in which cavities.

83. An automated centrifuge system according to claim 75, the robot being further capable of removing a plurality of the centrifuge vessels from a plurality of cavities in a same cluster of the centrifuge rotor at the same time.

84. An automated centrifuge system according to claim 75, the system further comprising a centrifuge.

85. An automated centrifuge system comprising:
a centrifuge rotor for use with the centrifuge, the centrifuge rotor comprising a rotor body defining a plurality of cavities into which centrifuge vessels containing material to be centrifuged may be removeably positioned, the plurality of cavities being positioned in two of more clusters about the rotor body, each cluster comprising at least two cavities which are oriented relative to each other such that longitudinal axes of the cavities in the cluster are parallel with each other; and
a robot capable of positioning a plurality probes into a plurality of cavities in a same cluster of the centrifuge rotor at the same time, the probes being capable of performing a function upon a plurality of samples in the centrifuge vessels in the cavities at the same time.

86. An automated centrifuge system according to claim 85 wherein the plurality of probes are capable of performing a function on at least 3 different samples at the same time.

87. An automated centrifuge system according to claim 85 wherein the plurality of probes are capable of performing a function on at least 4 different samples at the same time.

88. An automated centrifuge system according to claim 85 wherein the plurality of probes are capable of performing a function on at least 6 different samples at the same time.

89. An automated centrifuge system according to claim 85 wherein the plurality of probes are capable of performing a function on at least 8 different samples at the same time.

90. An automated centrifuge system according to claim 85 wherein the plurality of probes are capable of performing a function on at least 16 different samples at the same time.

91. An automated centrifuge system according to claim 85 wherein the plurality of probes are capable of performing a function on at least 32 different samples at the same time.

92. An automated centrifuge system according to claim 85 wherein the function is selected from the group consisting of removing material from a sample, dispensing material into a sample, vibrating a sample, and measuring a property of the sample.

93. An automated centrifuge system according to claim 85 wherein the function is aspirating fluid from the sample and the probes comprise tubes for performing the aspirating function.

94. An automated centrifuge system according to claim 85 wherein the function is sonicating a sample and the probes are sonication rods.

95. An automated centrifuge system according to claim 85 wherein the function is dispensing material into the sample and the probes comprise tubes for performing the dispensing function.

96. An automated centrifuge system according to claim 85, the system further comprising logic for controlling a reorientation of the centrifuge head relative to the robot such that the robot is capable of positioning the probes into cavities of different clusters of the centrifuge rotor.

97. An automated centrifuge system according to claim 85, the system further comprising logic for tracking which centrifuge vessels are positioned in which cavities.

98. An automated centrifuge system according to claim 85, the system further comprising logic for tracking what function has been performed on which sample.

99. An automated centrifuge system according to claim 85, the system further comprising a centrifuge.

100. An automated method for introducing a plurality of centrifuge vessels into a centrifuge head comprising:
having a robot attach a plurality of centrifuge vessels to an arm of the robot;
having the robot move the plurality of centrifuge vessels adjacent a centrifuge rotor, the centrifuge rotor comprising a rotor body defining a plurality of cavities into which the centrifuge vessels may be removeably positioned, the plurality of cavities being positioned in two of more clusters about the rotor body, each cluster comprising at least 2 cavities which are oriented relative to each other such that longitudinal axes of the cavities in the cluster are parallel with each other; and
having the robot position the plurality of centrifuge vessels into a plurality of cavities in a same cluster of the centrifuge rotor at the same time.

101. An automated method according to claim 100 wherein the robot positions at least 3 centrifuge vessels into cavities in a same cluster of the centrifuge rotor at the same time.

102. An automated method according to claim 100 wherein the robot positions at least 4 centrifuge vessels into cavities in a same cluster of the centrifuge rotor at the same time.

103. An automated method according to claim 100 wherein the robot positions at least 8 centrifuge vessels into cavities in a same cluster of the centrifuge rotor at the same time.

104. An automated method according to claim 100 wherein the robot positions at least 16 centrifuge vessels into cavities in a same cluster of the centrifuge rotor at the same time.

105. An automated method according to claim 100 wherein the robot positions at least 32 centrifuge vessels into cavities in a same cluster of the centrifuge rotor at the same time.

106. An automated method according to claim 100, the method further comprising
having the robot attach a second plurality of centrifuge vessels to the arm of the robot; and
having the robot position the second plurality of centrifuge vessels into a plurality of cavities in a second, different cluster of the centrifuge rotor, the second plurality of centrifuge vessels being positioned at the same time.

107. An automated method for introducing a plurality of centrifuge vessels into a centrifuge head comprising:
taking a centrifuge rotor comprising a rotor body defining a plurality of cavities into which centrifuge vessels are removeably positioned, the plurality of cavities being positioned in two of more clusters about the rotor body, each cluster comprising at least 2 cavities which are oriented relative to each other such that longitudinal axes of the cavities in the cluster are parallel with each other;
having a robot position a plurality probes into a plurality of cavities in a same cluster of the centrifuge rotor at the same time; and
having the probes perform a function upon a plurality of samples in the centrifuge vessels in the cavities at the same time.

108. An automated method according to claim 107 wherein the plurality of probes perform a function on at least 3 different samples at the same time.

109. An automated method according to claim 107 wherein the plurality of probes perform a function on at least 4 different samples at the same time.

110. An automated method according to claim 107 wherein the plurality of probes perform a function on at least 6 different samples at the same time.

111. An automated method according to claim 107 wherein the plurality of probes perform a function on at least 8 different samples at the same time.

112. An automated method according to claim 107 wherein the plurality of probes perform a function on at least 16 different samples at the same time.

113. An automated method according to claim 107 wherein the plurality of probes perform a function on at least 32 different samples at the same time.

114. An automated method according to claim 107 wherein the function performed is selected from the group consisting of removing material from a sample, dispensing material into a sample, vibrating a sample, and measuring a property of the sample.

115. An automated method according to claim 107 wherein the function is aspirating fluid from the sample.

116. An automated method according to claim 107 wherein the function is sonicating a sample.

117. An automated method for processing a sample comprising:
having a first robot attach a plurality of centrifuge vessels to an arm of the first robot, each centrifuge vessel containing a sample to be processed;
having the first robot move the plurality of centrifuge vessels adjacent a centrifuge rotor, the centrifuge rotor comprising a rotor body defining a plurality of cavities into which the centrifuge vessels may be removeably positioned, the plurality of cavities being positioned in two of more clusters about the rotor body, each cluster comprising at least 2 cavities which are oriented relative to each other such that longitudinal axes of the cavities in the cluster are parallel with each other;
having the first robot position the plurality of centrifuge vessels into a plurality of cavities in a same cluster of the centrifuge rotor at the same time;
repeating the first robot attachment and positioning steps until centrifuge vessels are positioned in multiple clusters of cavities in the centrifuge head;
centrifuging the samples in the centrifuge vessels in the centrifuge head; and
processing the centrifuged samples in the centrifuge vessels by having a second robot position a plurality probes into a plurality of cavities in a same cluster of the centrifuge rotor at the same time, and having the probes perform a function upon a plurality of samples in the centrifuge vessels in the cavities at the same time, repeating the second robot positioning and function performing steps for the samples in the centrifuge head.

118. An automated method according to claim 117 wherein the plurality of probes perform a function on at least 3 different samples at the same time.

119. An automated method according to claim 117 wherein the plurality of probes perform a function on at least 4 different samples at the same time.

120. An automated method according to claim 117 wherein the plurality of probes perform a function on at least 6 different samples at the same time.

121. An automated method according to claim 117 wherein the plurality of probes perform a function on at least 8 different samples at the same time.

122. An automated method according to claim 117 wherein the plurality of probes perform a function on at least 16 different samples at the same time.

123. An automated method according to claim 117 wherein the plurality of probes perform a function on at least 32 different samples at the same time.

124. An automated method according to claim 117 wherein the function performed is selected from the group consisting of removing material from a sample, dispensing material into a sample, vibrating a sample, and measuring a property of the sample.

125. An automated method according to claim 117 wherein the function is aspirating fluid from the sample.

126. An automated method according to claim 117 wherein the function is sonicating a sample.

127. An automated method according to claim 117 wherein the sample is a fermentation sample, the function comprising removing supernatant from the centrifuged sample.

128. An automated method according to claim 127, the method further comprising having a third robot employ probes to remove a cell pellet from the centrifuged centrifuge vessels.

129. An automated method according to claim 128, the method further comprising reintroducing the removed supernatant into the corresponding centrifuge vessels.

130. An automated method according to claim 129, the method further comprising centrifuging the removed supernatant once reintroduced into the corresponding centrifuge vessels.

131. The automated centrifuge system of claim 1, further comprising means for recognizing the tube when the tube is inserted into the cavity and an indexing means for tracking the tube when it is transferred from the automated centrifuge system to a separate system or device.

132. The method of claim 26, further comprising the steps of recognizing the vessel when the vessel is inserted into the cavity and tracking the tube when it is transferred from the centrifuge rotor cavity to a separate system or device
